(19) United States
(12) Patent Application Publication
(10) Pub. No.: US 2025/0227030 A1
(43) Pub. Date: Jul. 10, 2025

(54) INTENT-BASED MANAGEMENT OF CLOUD-NATIVE NETWORK FUNCTIONS

(71) Applicant: Telefonaktiebolaget LM Ericsson (publ), Stockholm (SE)

(72) Inventors: Malgorzata Svensson, Nattraby (SE); Kian Jennings, Athlone (IE); Jorg Niemoller, Sollentuna (SE); Robin Kiss, Budapest (HU); Larry O'Neill, Dublin (IE)

(21) Appl. No.: 18/849,846

(22) PCT Filed: Mar. 28, 2022
(86) PCT No.: PCT/EP2022/058051

§ 371 Date: Sep. 23, 2024

(51) Int. Cl. H04L 41/0895; H04L 41/14

(52) U.S. Cl. CPC H04L 41/0895; H04L 41/145

(57) ABSTRACT

A method for configuring a system is provided. The method comprises a first entity obtaining function information identifying a Cloud-Native Network Function, CNF, to be provided by the system and using the obtained function information, the first entity identifying the CNF to be provided by the system. The method further comprises the first entity transmitting to a second entity a request for deployment information, wherein the deployment information is about a deployment of one or more microservices for providing the identified CNF. The method further comprises the first entity receiving from the second entity the requested deployment information and using the deployment information, deploying in the system said one or more microservices for providing the CNF.

### TECHNICAL FIELD

Disclosed are embodiments related to methods and systems for providing intent-based management of Cloud-Native Network Functions (CNFs).

### BACKGROUND

Traditionally, a network function is provided using proprietary hardware (e.g., IPv4/v6 router, L2 bridge/switch, Virtual Private Network (VPN) gateway, etc.) and software. However, using the proprietary hardware and software to provide a network function limits where the network function can be provided.

A Cloud-Native Network Function (CNF) is a software implementation of a network function that is traditionally performed on a physical device. It is built and deployed in a cloud-native way. CNF entails migration from custom-built hardware to software running on generic hardware. By separating network functions from custom-built hardware, different CNFs can be provided using the same generic hardware, thereby increasing flexibility for service providers.

### SUMMARY

Service providers often want to add or update CNFs. Conventionally, in order for service providers to manage CNFs, the service providers must determine detailed system settings for CNFs and implement the determined system settings manually. However, such manual management is generally not efficient and can be problematic as the number of CNFs to manage increases.

Accordingly, in one aspect of some embodiments of this disclosure, there is provided a method for configuring a system. The method comprises a first entity obtaining function information identifying a Cloud-Native Network Function, CNF, to be provided by the system, and using the obtained function information, the first entity identifying the CNF to be provided by the system. The method further comprises the first entity transmitting to a second entity a request for deployment information, wherein the deployment information is about a deployment of one or more microservices for providing the identified CNF. The method further comprises the first entity receiving from the second entity the requested deployment information; and using the deployment information, triggering to deploy in the system said one or more microservices for providing the CNF.

In another aspect, there is provided a computer program comprising instructions which when executed by processing circuitry cause the processing circuitry to perform the method described above.

In another aspect, there is provided an apparatus for configuring a system. The apparatus is configured to obtain function information identifying a Cloud-Native Network Function, CNF, to be provided by the system, and using the obtained function information, identify the CNF to be provided by the system. The apparatus is further configured to transmit to a second entity a request for deployment information, wherein the deployment information is about a deployment of one or more microservices for providing the identified CNF. The apparatus is further configured to receive from the second entity the requested deployment information; and using the deployment information, trigger to deploy in the system said one or more microservices for providing the CNF.

In another aspect, there is provided an apparatus comprising a processing circuitry and a memory. The memory contains instructions executable by said processing circuitry, whereby the apparatus is operative to perform the method described above.

Embodiments of this disclosure provide an improved method and/or system for providing life-cycle management of CNFs.

The accompanying drawings, which are incorporated herein and form part of the specification, illustrate various embodiments.

### BRIEF DESCRIPTION OF THE DRAWINGS

FIG. 1 shows a system according to some embodiments.

FIG. 2 shows an implementation of User Plane Function (UPF) in a wireless system.

FIG. 3 shows a message flow diagram according to some embodiments.

FIG. 4 shows a process according to some embodiments.

FIG. 5 shows a block diagram of an apparatus according to some embodiments.

### DETAILED DESCRIPTION

As discussed above, to manage CNFs efficiently, an automation of CNF management is desirable. The automation of CNF management allows improving service quality while reducing management costs. In order to achieve the automation of CNF management, in the embodiments of this disclosure, intent-based management of CNFs is provided.

In this disclosure, for simplicity, the embodiments are described using a single CNF. However, the embodiments are applicable to multiple CNFs.

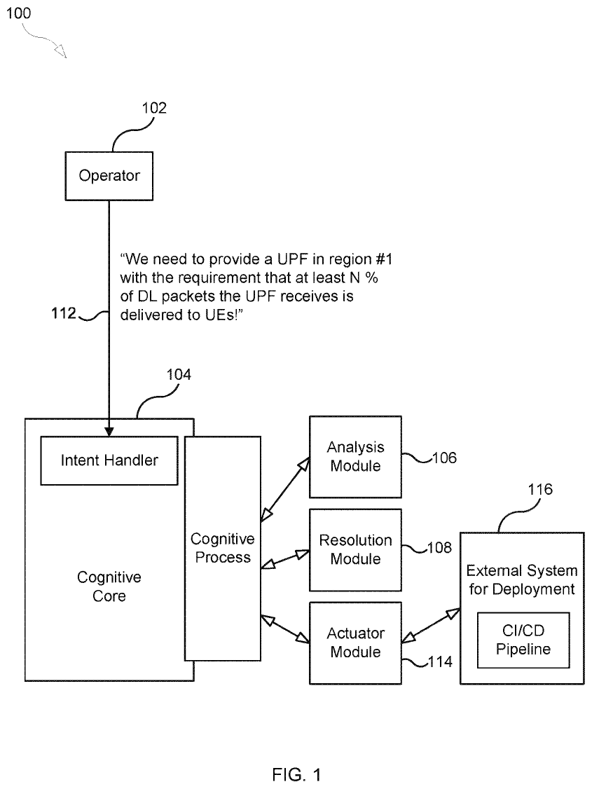

FIG. 1 shows a system 100 for providing intent-based CNF management according to some embodiments. As shown in FIG. 1, in the intent-based CNF management, instead of an operator 102 generating and implementing detailed system configurations for providing a desired CNF, operator 102 provides intent 112 to an intent manager (a.k.a., “cognitive core”) 104, and cognitive core 104 performs a cognitive process which involves interacting with analysis module 106, resolution module 108, and actuator module 114, thereby automatically changing system configuration(s) needed for providing the desired CNF.

Operator 102 may be configured to decompose a desired service into one or more CNFs with corresponding expectations in term of microservices to be used for providing the CNFs, CNF software composition, and/or possible target environments and locations to deploy the CNFs. Operator 102 may transmit intent 112 including the decomposed information to cognitive core 104.

Operator 102 may be a human, a computing device, or a software module, and each of the modules shown in FIG. 1 may correspond to a hardware or a software module (e.g., lines of program code).

Intent 112 is an information element (i.e., a software object) indicating desired specification (including requirements, goals, and constraints) of a CNF to be provided by external system 116 for deployment (herein after, “ES 116”). In other words, intent 112 indicates what operator 102 wants from ES 116. Examples of the CNF include User Plane Function (UPF), Session Management Function (SMF), Access and Mobility Management Function (AMF), Policy Control Function (PCF), Application Function (AF), IP Multimedia Subsystem (IMS), and Call Session Control Function (CSCF).

In the example shown in FIG. 1, intent 112 may indicate that operator 102 wants ES 116 to provide a CNF serving as an UPF in a geographical location #1 with the requirement that at least N % of downlink (DL) packets the UPF receives is delivered to user equipments (UEs).

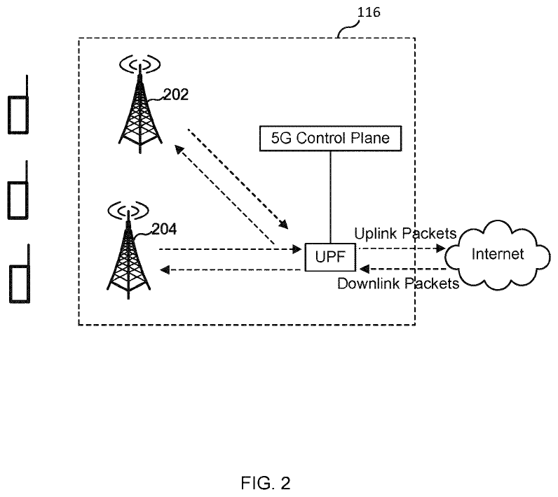

The UPF is one of network functions of 5G core network (5GC). As shown in FIG. 2, the UPF connects base stations 202 and 204 of Radio Access Network (RAN) to internet. The UPF is responsible for packet routing and forwarding, packet inspection, Qualify of Service (QoS) handling, and external Packet Data Unit (PDU) session for interconnecting Data Network (DN).

Referring back to FIG. 1, intent 112 may indicate desired specification (including requirements, goals, and constraints) of a CNF to be provided by ES 116. For example, in the exemplary scenario illustrated in FIG. 1, intent 112 may indicate that operator 102 wants ES 116 to provide a CNF serving as an UPF in the geographical location #1 with the requirement that at least N % of DL packets the UPF receives is delivered to UEs. Table 1 below shows a simplified example of information included in intent 112.

TABLE 1
OBJECT: INTENT

| | |
|---|---|
| CNF Type Identifier | CNF Type ID #1 (e.g., identifying a UPF) |
| Location Identifier | Location Identifier #1 (e.g., identifying |
| | the geographical location #1) |
| Requirement Data | “at least N % of DL packets the UPF receives |
| | should be delivered to UEs.” |

As shown in Table 1 above, the information included in intent 112 may include a CNF type identifier identifying a desired type of CNF and a location identifier identifying a geographical location where the desired CNF to be deployed. Additionally, intent 112 may include requirement data indicating one or more requirements related to providing the CNF. In the example shown in Table 1 above, the requirement is that at least N % of DL packets the UPF receives should be delivered to UEs.

Examples of different types of CNFs include UPF, SMF, AMF, PCF, AF, IMS, and CSCF, and examples of the location identifier include a country code, an area code, a zip code, and a cell identifier corresponding to a geographical region.

In some embodiments, the CNF may be collectively provided by a plurality of microservices. For example, a UPF may be provided using a first microservice corresponding to an intermediate UPF (I-UPF) and a second microservice corresponding to a PDU Session Anchor (PSA). In such embodiments, instead of or in addition to the CNF type identifier, intent 112 may also include one or more microservice type identifiers identifying different types of microservices needed for providing the desired CNF.

After receiving intent 112, cognitive core 104 may perform intent processing and execution of a cognitive process to achieve operator 102's intent. More specifically, cognitive core 104 may identify one or more configuration changes and implement the configuration change(s) in ES 116. To identify and implement the configuration change(s) in accordance with intent 112, system 100 performs various knowledge-centric operations.

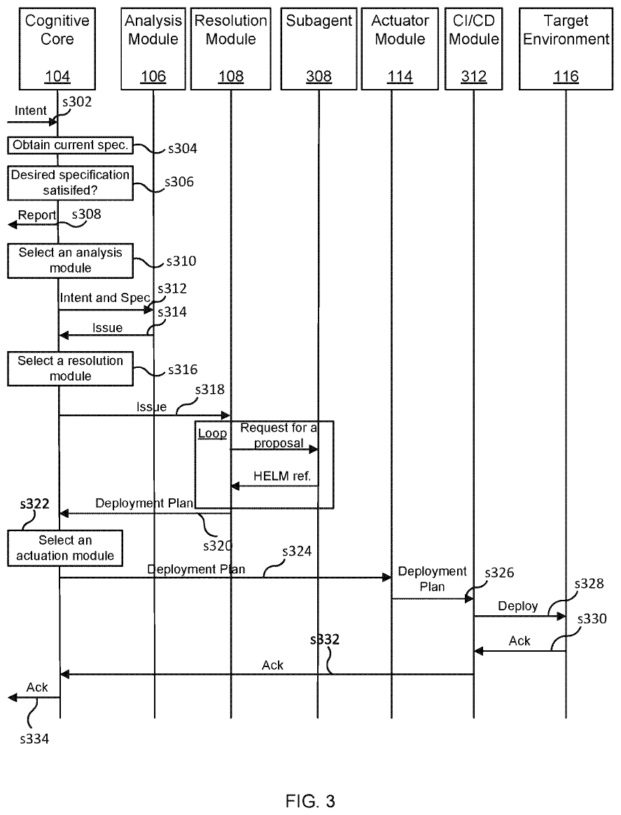

FIG. 3 shows a process 300 of providing intent-based management of a CNF according to some embodiments. Process 300 may be performed by system 100. As shown in FIG. 3, process 300 may begin with step s302.

Step s302 comprises cognitive core 104 (corresponding to cognitive core 104 shown in FIG. 1A) receiving intent 112 (a.k.a., “function information”). As discussed above, intent 112 is an information element (i.e., a software object) indicating desired specification (including requirements, goals, and constraints) of a CNF to be provided by ES 116. For example, as shown in Table 1 above, intent 112 may include a CNF type identifier identifying a particular type of CNF, a location identifier identifying a geographical location where the CNF is to be deployed, and requirement data indicating one or more requirements related to providing the CNF. In some embodiments, instead of or in addition to the CNF type identifier, a group of microservice type identifiers identifying a group of microservices needed for providing the CNF may be included in intent 112.

After receiving intent 112, cognitive core 104 may perform step s304. Step s304 comprises cognitive core 104 obtaining current specification of ES 116. The current specification may include a list of CNF type identifiers identifying types of CNFs that are currently provided by ES 116 and a list of location identifiers identifying locations where the CNFs are currently provided. Additionally, the current specification may indicate current operational states of ES 116 with respect to providing the CNFs. An example of such operational states is a ratio of the amount of DL packets a CNF serving as a UPF received and the amount of DL packets the CNF delivered to UEs.

Table 2 below shows a simplified example of information included in the current specification.

TABLE 2

| Current | CNF Type | | |
|---|---|---|---|
| Spec. | Identifier | Location Identifier | Operational States |
| Spec #1 | CNF type ID #1 | Location ID #1 | Operational State #1 |
| | (e.g., identifying | (e.g., identifying a first | |
| | UPF) | geographical region) | |
| Spec #2 | CNF type ID #2 | Location ID #2 | Operational State #3 |
| | (e.g., identifying | (e.g., identifying a second | |
| | IMS) | geographical region) | |
| Spec #3 | CNF type ID #3 | Location ID #3 | Operational State #3 |
| | (e.g., identifying | (e.g., identifying a third | |
| | UPF) | geographical region) | |

In the example shown in Table 2, the current specification indicates that a CNF serving as a UPF is currently deployed in the first and third geographical regions, and a CNF serving as an IMF is currently deployed in the second geographical region. The current specification may also indicate that ES 116 has operational state #1 with respect to providing a UPS in the first geographical region, operational state #2 with respect to providing an IMS in the second geographical region, and operational state #3 with respect to providing a UPS in the third geographical region.

Even though FIG. 3 shows that step s304 is performed after step s302 is performed, in some embodiments, step s304 may be performed before step s302 is performed.

The current specification of ES 116 may be obtained from a storage medium. The storage medium may be included in cognitive core 104 or may be included in an external module. Alternatively, some part(s) of the current specification may be obtained from a storage medium included in cognitive core 104 and other part(s) of the current specification may be obtained from a storage medium included in an external module. The storage medium may be a single integrated entity or a group of distributed entities.

In some embodiments, cognitive core 104 may store information about the desired specification and the current specification in a knowledge base. The information may be stored as graphs.

After receiving the desired specification and obtaining the current specification of ES 116, in step s306, cognitive core 104 may determine whether ES 116 satisfies the desired specification. More specifically, cognitive core 104 may determine whether there are any discrepancies between the desired specification and the current specification of ES 116.

In case cognitive core 104 determines that there is no discrepancy between the desired specification and the current specification of ES 116, cognitive core 104 may wait before it reevaluates as to whether ES 116 satisfies the desired specification. In some embodiments, cognitive core 104 may wait until a triggering event occurs. Examples of the triggering event are an elapse of a predetermined amount of time interval and an occurrence of one or more configuration changes within ES 116.

In some scenarios, cognitive core 104 may determine that there is a discrepancy between the desired specification and the current specification of ES 116. For example, the current specification of ES 116 may indicate that ES 116 currently does not provide a particular type of CNF in a particular location as indicated by intent 112. More specifically, while intent 112 may indicate that a CNF serving as a UPF needs to be deployed in a geographical region #4, the current specification of ES 116 may indicate that a CNF serving as a UPF is not currently deployed in the geographical region #4. In another example, the current specification of ES 116 may indicate that only N % of DL packets the UPF in the region #1 received is delivered to UEs while intent 112 may indicate that more than N % of DL packets the UPF received needs to be delivered to the UEs.

After cognitive core 104 determines whether ES 116 currently satisfies the desired specification (i.e., after determining whether there is a discrepancy between the current specification and the desired specification), in step s308, cognitive core 104 may transmit to operator 102 a report indicating the determination.

In case cognitive core 104 determines that ES 116 currently does not satisfy the desired specification, process 300 may proceed to step s310, as shown in FIG. 3.

In step s310, cognitive core 104 may select from a plurality of analysis modules an analysis module (a.k.a., a “function agent”) 106 which is capable of analyzing intent 112 and the current specification, and identifying the issue to address. In some embodiments, the list of the plurality of analysis modules may be stored in the knowledge base. After selecting analysis module 106, in step s312, cognitive core 104 may transmit to analysis module 106 intent 112 and the current specification of ES 116. In some embodiments, instead of transmitting the entire data corresponding to intent 112 and the current specification of ES 116, cognitive core 104 may only transmit portions of intent 112 and the current specification, which are needed for analysis module 106 to identify an issue associated with the discrepancy.

After receiving intent 112 and the current specification of ES 116, analysis module 106 may perform an analysis of the discrepancy between intent 112 and the current specification of ES 116, and identify an issue to address for resolving the discrepancy.

For example, in one of the exemplary scenarios, the discrepancy is that ES 116 currently does not provide a particular type of CNF in a particular location as indicated by intent 112. In another of the exemplary scenarios, the discrepancy is that the current specification of ES 116 indicates that N % of DL packets the UPF in the region #1 received is not delivered to UEs while intent 112 indicates that more than N % of DL packets the UPF receives needs to be delivered to UEs. In this scenario, analysis module 106 may determine that the issue is that many UEs in the region #1 frequently go idle while the maximum number of DL packets the UPF buffers is too small.

There are different ways for analysis module 106 to identify the issue. In one example, analysis module 106 may obtain data providing mappings between different types of discrepancies and different types of issues. Table 3 below shows a simplified example of such mappings.

TABLE 3

| Discrepancy Types | Issue Types |
|---|---|
| Discrepancy type #1 | Potential Issue Type #1 |
| | Potential Issue Type #2 |
| Discrepancy type #2 | Potential Issue Type #3 |
| Discrepancy type #3 | Potential Issue Type #4 |
| | Potential Issue Type #5 |
| | Potential Issue Type #6 |

In other examples, analysis module 202 may perform logic operations and/or use machine learning (ML) models to perform the analysis.

Once analysis module 106 identifies the issue, in step s314, analysis module 106 may transmit to cognitive core 104 information indicating the identified type of the issue (e.g., a message containing an issue type identifier identifying the type of the issue).

Even though FIG. 3 shows that cognitive core 104 and analysis module 106 are separate modules, in some embodiments, cognitive core 104 and analysis module 106 may be an integrated single module.

After cognitive core 104 receives the information indicating the identified issue, in step s316, cognitive core 104 may select from a group of one or more resolution modules a resolution module 108 which is capable of determining a deployment plan to address the identified issue. In order to perform such selection, in some embodiments, cognitive core 104 may obtain a database providing mappings between a list of issues and a list of resolution modules mapped to the list of issues. Table 4 below shows a simplified example of such mappings.

TABLE 4

| Issue Types | Resolution Module |
|---|---|
| Issue Type #1 | Resolution Module #1 |
| Issue Type #2 | Resolution Module #3 |
| Issue Type #3 | Resolution Module #4 |

In some embodiments, the list of the plurality of resolution modules may be stored in the knowledge base.

After cognitive core 104 selects resolution module 108, in step s318, cognitive core 104 may transmit to resolution module 108 a request for deployment plan, where the request includes information indicating the identified issue.

After resolution module 108 receives the information indicating the identified issue, it may determine a deployment plan. In one of the exemplary scenario provided above (where the discrepancy is that ES 116 currently does not provide a particular type of CNF in a particular location as indicated by intent 112), the deployment plan may be configuring a CNF instance to serve as a UPF in the particular location. In some embodiments, the deployment plan may indicate configuring a plurality of microservices such that the microservices are collectively used for providing the particular type of CNF (e.g., UPF) in the particular location.

In another one of the exemplary scenarios provided above (where the discrepancy is that the current specification of ES 116 indicates that N % of DL packets the UPF in the region #1 received is not delivered to UEs while intent 112 indicates that more than N % of DL packets the UPF receives needs to be delivered to UEs), the deployment plan may be modifying the Buffering Action Rules (BARs) of the UPF to increase the maximum number of packets (and the maximum duration) to buffer.

Like analysis module 106, resolution module 108 may determine the deployment plan using any one or a combination of data mapping various issues to various deployment plans, logic operations, and/or ML models. Alternatively, in order to determine the deployment plan, in some embodiments, resolution module 108 may rely on a different entity (e.g., subagent module 308). In such embodiments, resolution module 108 may transmit to subagent module 308 a request for a proposal, and in response to receiving the request, subagent module 308 may transmit to resolution module 108 the requested proposal. The requested proposal may include references to HELM files/charts.

After determining the deployment plan, in step s320, resolution module 108 may transmit to cognitive core 104 information indicating the deployment plan. In some embodiments, the deployment plan may be provided in the form of references to HELM charts/files.

After receiving the information indicating the deployment plan, in step s322, cognitive core 104 may select from a plurality of actuator modules an actuator module (a.k.a., “pipeline hander agent”) 114. In some embodiments, the list of the plurality of actuation modules may be stored in the knowledge base.

After selecting actuator module 114, in step s324, cognitive core 104 may transmit to actuator module 114 the information indicating the determined deployment plan. In step s326, actuator module 114 forwards the received information indicating the determined deployment plan to Continuous Integration (CI)/Continuous Delivery (CD) module 210.

In case the determined deployment plan is provided in the form of references to HELM files/charts, after receiving the information indicating the deployment plan, in step s328, CI/CD module 210 may resolve the references to HELM files/charts (e.g., inputting the HELM files/charts to deployment templates) and implement the configuration change(s) in ES 116 (a.k.a., “target deployment environment”). In some embodiments, the deployment plan may be stored in the knowledge base in cognitive core 104.

After the configuration change(s) are successfully implemented in ES 116, in step s330, ES 116 may transmit to CI/CD module 210 a message indicating the successful implementation of the configuration change(s) in ES 116.

After receiving the message, in step s332, CI/CD module 210 may transmit to cognitive core 104 a message indicating the successful implementation of the configuration change(s), and after receiving the message, in step s334, cognitive core 104 may notify to operator 102 the successful implementation of the configuration change(s) in ES 116.

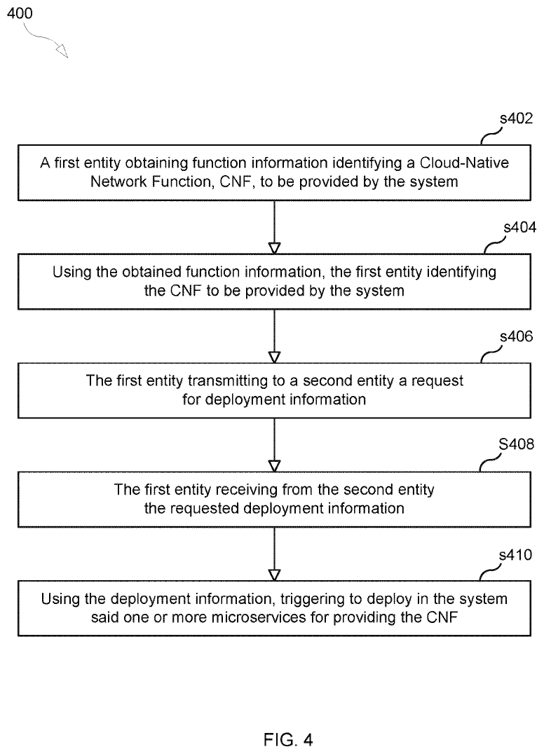

FIG. 4 shows a process 400 for configuring a system according to some embodiments. Process 400 may begin with step s402. Step s402 comprises a first entity obtaining function information identifying a Cloud-Native Network Function, CNF, to be provided by the system. Step s404 comprises using the obtained function information, the first entity identifying the CNF to be provided by the system. Step s406 comprises the first entity transmitting to a second entity a request for deployment information, wherein the deployment information is about a deployment of one or more microservices for providing the identified CNF. Step s408 comprises the first entity receiving from the second entity the requested deployment information. Step s410 comprises using the deployment information, triggering to deploy in the system said one or more microservices for providing the CNF.

In some embodiments, the CNF is any one of the followings: User Plane Function, UPF, Session Management Function, SMF, Access and Mobility Management Function, AMF, Policy Control Function, PCF, Application Function, AF, IP Multimedia Subsystem, IMS, and Call Session Control Function, CSCF.

In some embodiments, the function information includes a CNF identifier identifying the CNF.

In some embodiments, said one or more microservices are for collectively providing the CNF, and the function information comprises one or more microservice identifiers identifying said one or more microservices.

In some embodiments, the method further comprises based on analyzing the obtained function information, the first entity selecting a third entity from a group of entities, wherein the third entity is mapped to the CNF; the first entity transmitting to the third entity a request for information about one or more operational characteristics of the system to modify; and the first entity receiving from the third entity the requested information about said one or more operational characteristics to modify.

In some embodiments, the function information comprises one or more operational requirements related to providing the CNF. The method further comprises the third entity determining whether the system currently satisfies said one or more operational requirements; and as a result of determining that the system currently does not satisfy said one or more operational requirements, the third entity determining said one or more operational characteristics to modify.

In some embodiments, the second entity is selected from a group of second entities based on said one or more operational characteristics to modify.

In some embodiments, the deployment information includes one or more references to one or more HELM files or charts.

In some embodiments, the method further comprise obtaining one or more deployment templates; and adding said one or more HELM files or charts into said one or more deployment templates.

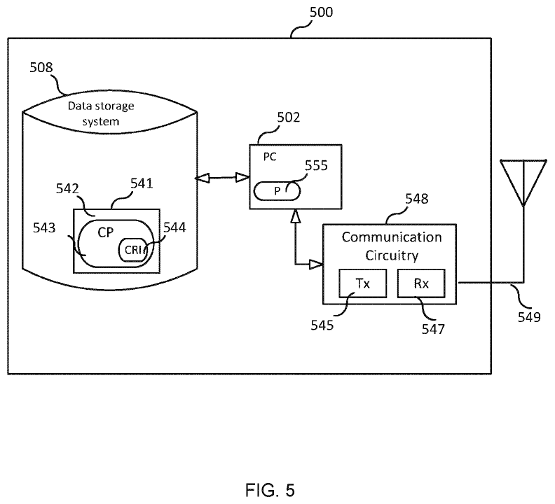

FIG. 5 shows an exemplary hardware implementation of any one of cognitive core 104, analysis module 106, resolution module 108, subagent 308, actuator module 114, or CI/CD module 312, according to some embodiments. As shown in FIG. 5, each entity may comprise: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like); communication circuitry 548, which is coupled to an antenna arrangement 549 comprising one or more antennas and which comprises a transmitter (Tx) 545 and a receiver (Rx) 547 for the module to transmit data and receive data (e.g., wirelessly transmit/receive data); and a local storage unit (a.k.a., “data storage system”) 508, which may include one or more non-volatile storage devices and/or one or more volatile storage devices. Even though FIG. 5 shows that the module includes communication circuitry 548 which comprises Tx 545 and Rx 547, and antenna arrangement 549, in some embodiments, communication circuitry 548 and antenna arrangement 549 may not be included in the module.

In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes the module to perform steps described herein (e.g., steps described herein with reference to the flow charts). In other embodiments, the module may be configured to perform steps described herein without the need for code. That is, for example, PC 502 may consist merely of one or more ASICs. Hence, the features of the embodiments described herein may be implemented in hardware and/or software.

1. A method (400) for configuring a system, the method comprising:
a first entity obtaining (s402) function information identifying a Cloud-Native Network Function, CNF, to be provided by the system;
using the obtained function information, the first entity identifying (s404) the CNF to be provided by the system;
the first entity transmitting (s406) to a second entity a request for deployment information, wherein the deployment information is about a deployment of one or more microservices for providing the identified CNF;
the first entity receiving (s408) from the second entity the requested deployment information; and
using the deployment information, triggering (s410) to deploy in the system said one or more microservices for providing the CNF.

2. The method of claim 1, wherein the CNF is any one of the followings: User Plane Function, UPF, Session Management Function, SMF, Access and Mobility Management Function, AMF, Policy Control Function, PCF, Application Function, AF, IP Multimedia Subsystem, IMS, and Call Session Control Function, CSCF.

3. The method of claim 1, wherein the function information includes a CNF identifier identifying the CNF.

4. The method of claim 1, wherein
said one or more microservices are for collectively providing the CNF, and
the function information comprises one or more microservice identifiers identifying said one or more microservices.

5. The method of claim 1, the method further comprising:
based on analyzing the obtained function information, the first entity selecting a third entity from a group of entities, wherein the third entity is mapped to the CNF;
the first entity transmitting to the third entity a request for information about one or more operational characteristics of the system to modify; and
the first entity receiving from the third entity the requested information about said one or more operational characteristics to modify.

6. The method of claim 5, wherein
the function information comprises one or more operational requirements related to providing the CNF, and
the method further comprises:
the third entity determining whether the system currently satisfies said one or more operational requirements; and
as a result of determining that the system currently does not satisfy said one or more operational requirements, the third entity determining said one or more operational characteristics to modify.

7. The method of claim 5, wherein the second entity is selected from a group of second entities based on said one or more operational characteristics to modify.

8. The method of claim 1, wherein the deployment information includes one or more references to one or more HELM files or charts.

9. The method of claim 8, the method further comprising:
obtaining one or more deployment templates; and
adding said one or more HELM files or charts into said one or more deployment templates.

10. A computer program (543) comprising instructions (544) which when executed by processing circuitry (502) cause the processing circuitry to perform the method of claim 1.

11. A carrier containing the computer program of claim 10, wherein the carrier is one of an electronic signal, an optical signal, a radio signal, and a computer readable storage medium.

12. An apparatus (500) for configuring a system, the apparatus being configured to:
obtain (s402) function information identifying a Cloud-Native Network Function, CNF, to be provided by the system;
using the obtained function information, identify (s404) the CNF to be provided by the system;
transmit (s406) to a second entity a request for deployment information, wherein the deployment information is about a deployment of one or more microservices for providing the identified CNF;
receive (s408) from the second entity the requested deployment information; and
using the deployment information, trigger (s410) to deploy in the system said one or more microservices for providing the CNF.

13. The apparatus of claim 12, wherein the CNF is any one of the followings: User Plane Function, UPF, Session Management Function, SMF, Access and Mobility Management Function, AMF, Policy Control Function, PCF, Application Function, AF, IP Multimedia Subsystem, IMS, and Call Session Control Function, CSCF.

14. An apparatus (500) comprising:
a processing circuitry (502); and
a memory (541), said memory containing instructions executable by said processing circuitry, whereby the apparatus is operative to perform the method of claim 1.
